(19) United States
(12) Patent Application Publication
(10) Pub. No.: US 2009/0014243 A1
(43) Pub. Date: Jan. 15, 2009

(54) BREATHER-SAMPLING-FILLER ASSEMBLY FOR LIQUID RESERVOIRS/SYSTEMS

(75) Inventor: John C. Whigham, Overland Park, KS (US)

Correspondence Address: HOVEY WILLIAMS LLP, 10801 Mastin Blvd., Suite 1000, Overland Park, KS, 66210, US

(73) Assignee: Petrolink USA, LLC, Olathe, KS (US)

(21) Appl. No.: 11/777,909

(22) Filed: Jul. 13, 2007

(51) Int. Cl. F16N 21/00

(52) U.S. Cl. 184/6; 184/105.3

(57) ABSTRACT

A breather-sampling-filler assembly (10) for liquid lubrication systems is provided which includes a primary unit (block) (14) adapted for permanent or semi-permanent attachment to a wall (12) of a lubrication system in covering relationship to a lubrication system access opening (13). The unit (14) includes individual breather, fill, and sampling ports (16, 18, 20), and is designed to support a breather (22) in communication with breather port (16), a fill assembly (24) in communication with fill port (18), and a sampling assembly (26) in communication with sampling port (20). The breather (22) includes at least one vent opening (60) and had a selected media (62) therein for desired treatment of solid and liquid airborne contaminants passing into and out of the lubrication system. Use of the assembly (10) permits continuous treatment of air entering and leaving the lubrication system (12), and also allows quick, trouble-free liquid filling and sampling while avoiding introduction of contaminants into the lubrication system liquid and air pollution from the lubrication system (12)

### BACKGROUND OF THE INVENTION

1. Field of the Invention

The present invention is broadly concerned with breather-sampling-filler assemblies adapted for permanent or semi-permanent attachment to a liquid lubrication system such as to a hydraulic fluid reservoir so as to permit fluid filling, liquid sampling and on-line oil reconditioning without the need for opening the lubrication system, thus greatly reducing spills and the ingression of liquid and solid contamination into the lubrication system. The sampling port allows for efficient and repeatable sampling practices and results. The assemblies also include a breather element serving to minimize and trap solid and liquid contaminants from the atmosphere passing into the lubrication system.

2. Description of the Prior Art

Most liquid lubrication systems are equipped with a filler opening which is capped using a threaded plug, screw on filler cap, or a quick disconnect fitting. When the lubrication system is to be filled or topped off with fluid, at times it is necessary to remove the cap, thus opening the lubrication system to the atmosphere. Next, liquid is dispensed through the reservoir opening from bulk containers such as pails, barrels, totes, or bulk reservoirs using transfer pumps/devices. In many instances filler hoses are employed, which are coupled with a pump in communication with a liquid supply. Similarly, when it is necessary to sample the liquid within the lubrication system, the filler cap must be removed and sampling apparatus passed through the opening to extract a liquid sample.

However accomplished, conventional lubrication system filling and sampling exposes the liquid within the lubrication system to the atmosphere and also often leads to contamination of the liquid in the reservoir and lubrication system. Liquid spills are also quite common during such filling/sampling operations. In addition, because conventional reservoir openings will accept a variety of different delivery equipment, it is possible that a given lubrication system may be improperly filled with the wrong liquid. For example, a hydraulic fluid reservoir may be mistakenly filled with non-hydraulic oil or the like, which can create equipment and/or component failure.

Another deficiency with conventional capped liquid lubrication systems is ingression of airborne solid and liquid contaminants from the atmosphere into the lubrication system. For example, excess moisture in a hydraulic system creates acid and ultimately chemically breaks down the fluid. In typical hydraulic fluid reservoirs moisture ingression from the atmosphere is not controlled, thus necessitating more frequent disposal of off specification fluid and refilling with new fluid.

The prior art is replete with a variety of lubrication system designs requiring periodic filling and/or sampling. Some of these designs attempt to address the foregoing problems, but none are entirely successful or all encompassing. For example, U.S. Pat. No. 5,503,659 describes a vent system for removing pollutants from gases vented from roof-mounted liquid storage reservoir, making use of a filtration system with sorptive media. However, the issues of quick, trouble-free liquid filling and sampling are not addressed. U.S. Pat. No. 5,170,819 describes a valve system for mobile tank cars and designed to facilitate loading or unloading of the cars. However, venting issues and the possible contamination of tank liquids or air pollution from the tanks are not solved. The following references describe other systems of background interest: U.S. Pat. Nos. 5,038,838, 5,033,637, 4,796,676, 4,723,573, 4,408,628, 4,028,075, and 3,172,581.

### SUMMARY OF THE INVENTION

The present invention minimizes the issues outlined above and provides an improved breather-sampling-filler assembly for use with a variety of liquid lubrication systems. The assemblies of the invention permit efficient filling and sampling operations, while essentially eliminating the potential of spills, atmospheric liquid contamination and air pollution, and introduction of dirt or other solid contaminants into the lubrication system liquid. Furthermore, the invention also allows for attachment of auxiliary oil reconditioning equipment while a system is operation versus having to shutdown the system to attach the equipment. Broadly speaking, preferred forms of the breather-sampling-filler assemblies of the invention are designed for attachment and securement to a liquid lubrication system and consist of a base unit having a breather port, a liquid fill port, and a liquid sampling port that all communicate with the interior of the lubrication system. The breather element may be operably coupled with the breather port that communicates with the interior of the reservoir and the atmosphere; the element media minimizes and traps solid, liquid and gaseous contaminants into and out of the lubrication system. A quick connect fill assembly is operably coupled with the liquid fill port and includes efficient filling of the lubrication system with liquid. Finally, a sampling assembly may be operably coupled with the sampling port and includes efficient withdrawal of samples of the liquid from within the lubrication system.

In preferred forms, the breather, fill, and sampling assembly are each supported on the primary unit so that the overall assembly presents a compact profile. The treatment breather is preferably secured to the upper surface of the primary unit, whereas the filling and sampling assemblies are side-mounted and each is equipped with a quick-connect valve fitting and cap.

### BRIEF DESCRIPTION OF THE DRAWINGS

FIG. 1 is a top perspective view of a breather-sampling-filler assembly in accordance with the invention, shown operatively mounted on a hydraulic fluid reservoir surface;

FIG. 2 is a bottom perspective view of the assembly;

FIG. 3 is a plan view of the assembly, with the contour of the upper desiccant breather illustrated in phantom;

FIG. 4 is a fragmentary vertical sectional view taken along line 4-4 of FIG. 3, and illustrating the construction of the filler port; and

FIG. 5 is a fragmentary vertical sectional view taken along line 5-5 of FIG. 3, and illustrating the construction of the sampling port.

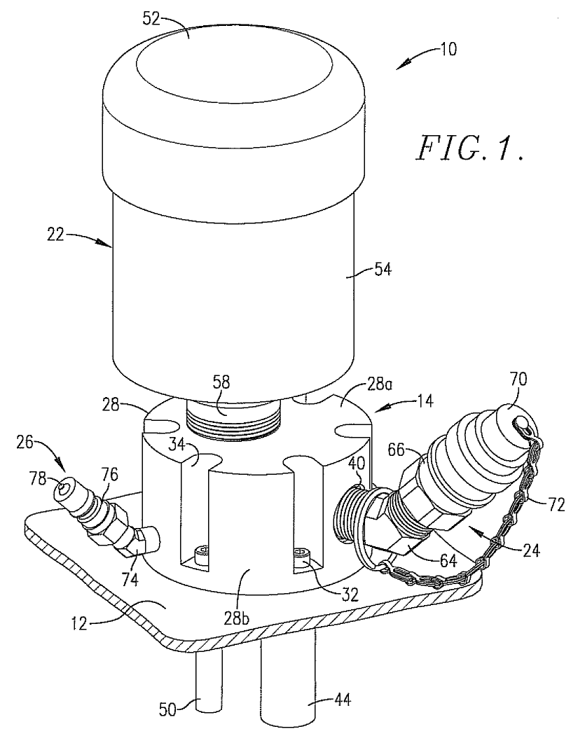

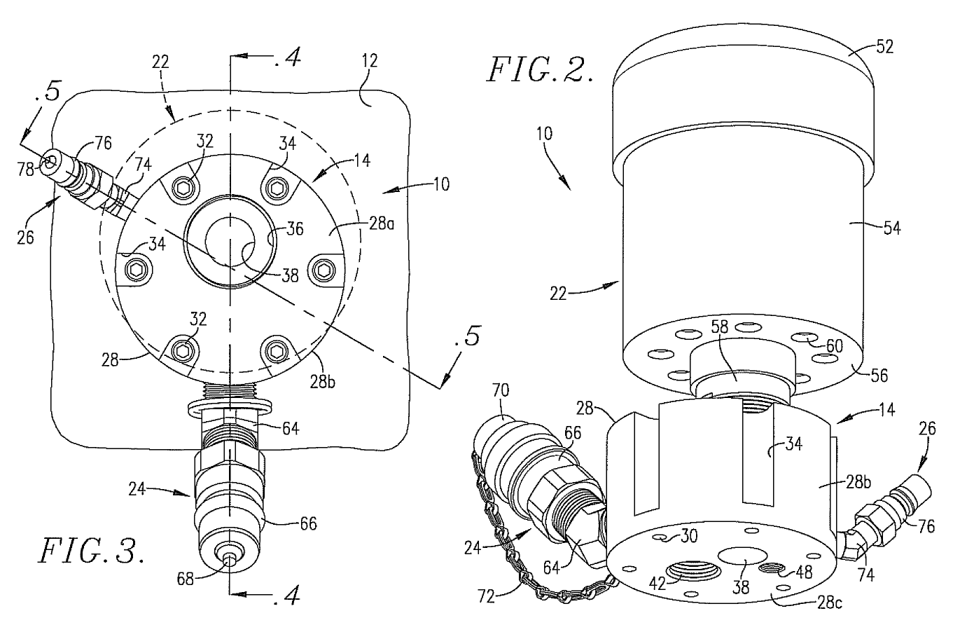

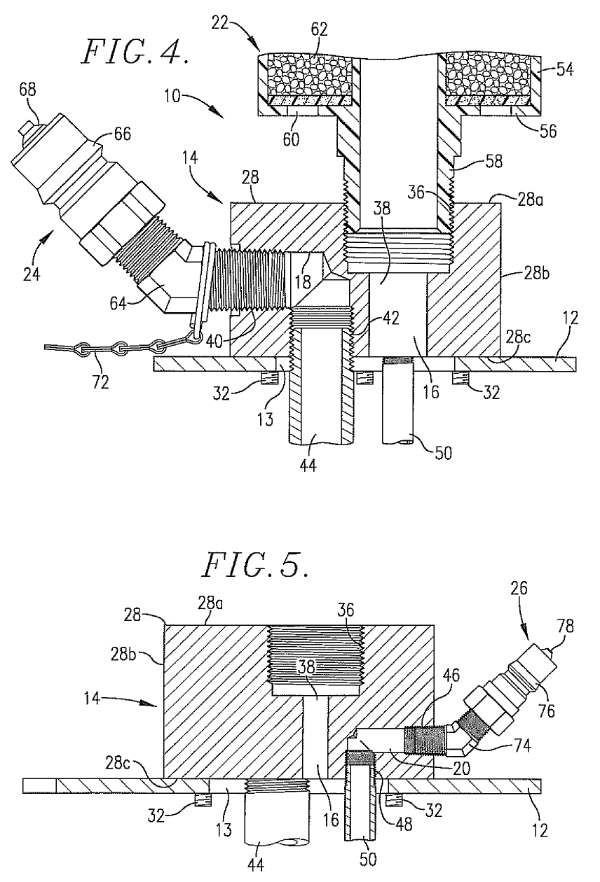

### DETAILED DESCRIPTION OF THE PREFERRED EMBODIMENTS

Turning now to the drawings, a breather-sampling-filler assembly 10 in accordance with the invention is designed for permanent or semi-permanent attachment to a wall 12 forming a part of a liquid lubrication system adjacent an access opening 13 therethrough, such as a hydraulic fluid reservoir (as used herein, A lubrication system refers to all types of lubricant-holding structures including conventional lubrication systems and reservoirs). Broadly speaking, the assembly 10 includes a primary block or unit 14 having individual breather, fill, and sampling ports 16, 18, and 20. Also, the assembly 10 has a breather 22 operably secured to the breather port 16; a fill assembly 24 operably secured with fill port 18; and a sampling assembly 26 operably secured with sampling port 20.

In detail, the unit (block) 14 is preferably a solid metal, generally cylindrical block 28 having top wall surface 28a, sidewall surface 28b, and bottom wall surface 28c, with a total of six circumferentially spaced apart attachment bores 30 passing through bottom wall surface 28c and each operable to receive a mounting screw 32. As illustrated, the sidewall surface 28b of block 28 has a series of vertical slots 34 formed therein and aligned with the attachment bores 30.

The breather port 16 is formed in block 28 and includes an upper threaded section 36 extending downwardly from top wall surface 28a and a lower section 38 extending downwardly through bottom wall surface 28c, to thus define a complete through-bore. The fill port 18 is generally L-shaped, including a threaded inlet section 40 extending through sidewall surface 28b and a threaded delivery section 42 extending through bottom wall surface 28c. The diameter of the port may vary allowing for easier flow of material through the port depending on the weight and viscosity of the fluids involved. Thus, preferred port sizes include threaded fittings for 0.5″, 1.0″, and 1.5″ pipes. A fill delivery pipe 44 is threaded into section 42 and extends through access opening 13 into the confines of the lubrication system. Finally, the sampling port 20 is also generally L-shaped, but of smaller diameter than fill port 18. It includes a threaded outlet section 46 passing through sidewall surface 28b as well as a threaded inlet section 48 extending through bottom wall surface 28c. A sampling pipe 50 is threaded into the section 48 and likewise extends through lubrication system wall access opening 13.

The breather 22 is in the form of an upright, hollow container having top wall 52, sidewall structure 54, and bottom wall 56. A depending, threaded tubular nipple 58 extends from bottom wall 56 and is threadably received within upper threaded section 36 of breather port 16. Thus the entire breather 22 is supported on unit (block) 14. The bottom wall 56 is also provided with a series of circumferentially spaced apart vent openings 60 serving to communicate the interior of the lubrication system with the atmosphere through breather port 16. In addition, the breather holds media 62 designed to treat gases into and out of the lubrication system through the breather. Where the presence of moisture within the lubrication system is a concern, the media 62 would be in the form of a desiccant, such as particulate calcium chloride. Where necessary, a gas-permeable screen or the like as shown could be provided across the vent openings 60 to prevent loss of media. Where the presence of solids within the lubrication system is a concern, the media would be in the form of a paper or microglass material.

The fill assembly 24 includes a threaded elbow 64 received within inlet section 40, as well as a quick-connect valve fitting 66 secured to the outer end of elbow 64. The fitting 66 is itself conventional and includes a central valve member 68. A mating filler unit (block) or nozzle (not shown) may be pressed onto fitting 66, which depresses valve 68 to open the valve and allow passage of liquid through the filler assembly 24 and into the lubrication system. An optional valve-covering cap 70 may be provided to cover the upper valve end of fitting 66, with the cap 70 retained by a tether chain 72.

The sampling assembly 26 also has a threaded elbow 74 with one end thereof received within section 46 of sampling port 20. An appropriately sized quick-connect fitting 76 is threadably mounted on the outer end of elbow 74, and has a central valve 78. The fitting 76 operates in the manner of fitting 66, thereby allowing a sampling device (not shown) to be attached to thereby open valve 78 and permit withdrawal of liquid samples from the lubrication system.

In use, the assembly 10 is preferably mounted in a permanent or semi-permanent manner onto lubrication system wall 12 in full covering relationship to access opening 13; this is accomplished by securing unit (block) 14 to lubrication system wall 12, using screws 32 extending through complementally threaded attachment bores (not shown) disposed about opening 13. With such mounting and an appropriately sized opening 13, both depending fill pipe 44 and sampling pipe 50 extend through lubrication system wall 12 into the confines of the lubrication system. In this orientation, gases may pass into and out of the lubrication system through breather port 16 and breather 22. When desiccant is used as the media within the breather, moisture is absorbed so as to prevent moisture buildup within the lubrication system. Other types of medias could also be used, e.g., where air pollution from the lubrication system is a concern, an appropriate adsorbent or absorbent fill could be employed to remove objectionable pollutants from gases exiting the lubrication system.

When it is desired to fill or top off the lubrication system with liquid, a mating filler unit (block) is pressed on to the fitting 66 so as to depress and open valve 68. This presents a liquid flow path through fitting 66, elbow 64, port 18, and delivery pipe 44, so that appropriate quantities of the liquid may be readily delivered to the lubrication system. Similarly, when it is desired to sample the liquid within the lubrication system for testing or inspection purposes, a properly sized withdrawal unit (block) is pressed onto fitting 76 of assembly 26, so as to depress valve 78. This creates a liquid flow path from the lubrication system through pipe 60, port 20, elbow 74, fitting 76, and valve 78, permitting withdrawal of sample quantities of liquid.

It will be appreciated that the assembly 10 affords a number of significant advantages. For example, use of the breather 22 permits continuous and selective treatment of gases passing into and out of the lubrication system. In the case of hydraulic fluids for example, moisture within the fluid can be a significant problem owing to buildup of acid levels. This is effectively controlled with the assembly 10 where the breather 22 is filled with an appropriate media. Further, lubrication system filling can be readily and quickly accomplished without fear of liquid contamination or spillage. This stems from the fact that there is no need to remove a conventional fill cap which can permit introduction of dirt or other contaminants. Furthermore, no special tools are needed to accomplish such filling. Also, if desired, individually-sized or otherwise custom filler fittings can be selected for different liquids to be dispensed, e.g., a single size of filler fitting may be used for all hydraulic fluid reservoirs, whereas a different size filler fitting could be used for other fluids. Thus, the possibility of filling a hydraulic fluid lubrication system with non-hydraulic fluid is essentially eliminated. Likewise, periodic sampling can be easily accomplished, again without the need for opening a fill cap and with the virtual certainty that no contaminants will be introduced into the fluid.

Although this invention has been described in terms of certain preferred embodiments and suggested possible modifications thereto, other embodiments and modifications apparent to those of ordinary skill in the art are also within the scope of this invention. Accordingly, the scope of the invention is intended to be defined by the claims which follow.

I claim:

1. A breather-sampling-filler assembly operable for attachment to a lubrication system and comprising:
a primary unit operable for securement to a lubrication system and having a breather port, a liquid fill port, and a liquid sampling port in communication with the interior of said lubrication system;
a breather operably coupled with said breather port and including at least one vent opening communicating the interior of the lubrication system with the atmosphere, and media within the breather for treatment of at least some of the gases passing through the breather;
a fill assembly operably coupled with said liquid fill port and including structure permitting filling of said lubrication system with liquid; and
a sampling assembly operably coupled with said sampling port and including structure permitting withdrawal of samples of said liquid from within said lubrication system.

2. The assembly of claim 1, said breather supported on said primary unit and including therein a quantity of media operable to remove solid and liquid contaminants passing into and out of said lubrication system through the breather.

3. The assembly of claim 1, said breather comprising an upright, body having a top wall, sidewall structure, and a bottom wall, said bottom wall having a plurality of vent openings formed therein.

4. The assembly of claim 3, said bottom wall having a depending, fitting, said unit having a complamental bore for receipt of said fitting.

5. The assembly of claim 1, said fill assembly supported on said primary unit.

6. The assembly of claim 1, said fill assembly comprising a tubular fill pipe operably secured to said unit and having a quick-connect valve fitting on said fill pipe.

7. The assembly of claim 6, said tubular fill pipe having a threaded inner end, said unit having a complementally threaded fill bore receiving said threaded inner end.

8. The assembly of claim 1, said fill assembly including a depending fluid delivery pipe extending into said lubrication system and operably coupled with said fill port.

9. The assembly of claim 1, said sampling assembly supported on said primary unit.

10. The assembly of claim 1, said sampling assembly comprising a tubular sampling pipe operably secured to said unit and having a quick-connect valve fitting on said sampling pipe.

11. The assembly of claim 10, said tubular sampling pipe having a threaded inner end, said unit having a complementally threaded sampling bore receiving said threaded inner end.

12. The assembly of claim 1, said sampling assembly including a depending sampling pipe extending into said lubrication system and operably coupled with said sampling port.

13. The assembly of claim 1, said breather, fill assembly, and sampling assembly each being operably supported on said unit, said unit being threadably secured to a wall of said lubrication system in covering relationship to an access opening in said lubrication system wall, said breather port, liquid port, and sampling port in communication with the interior of said lubrication system through said access opening.

14. The combination comprising:
a liquid lubrication system defined by lubrication system walls;
a breather-sampling-filler assembly operably coupled with a lubrication system wall and comprising B
a primary unit secured to said lubrication system wall and having a breather port, a liquid fill port, and a liquid sampling port in communication with the interior of said lubrication system;
a gas treatment breather operably coupled with said breather port and including at least one vent opening communicating the interior of the lubrication system with the atmosphere, and media within the breather for treatment of at least some of the gases passing through the breather;
a fill assembly operably coupled with said liquid fill port and including structure permitting selective filling of said lubrication system with liquid; and
a sampling assembly operably coupled with said sampling port and including structure permitting selective withdrawal of samples of said liquid from within said lubrication system.

15. The assembly of claim 14, said gas treatment breather supported on said primary unit and including therein a quantity of desiccant operable to remove moisture of gasses passing into and out of said lubrication system through the breather.

16. The assembly of claim 14, said breather comprising an upright, hollow body having a top wall, sidewall structure, and a bottom wall, said bottom wall having a plurality of vent openings formed therein.

17. The assembly of claim 16, said bottom wall having a depending, threaded nipple, said unit having a complementally threaded bore for receipt of said threaded nipple.

18. The assembly of claim 14, said fill assembly supported on said primary unit.

19. The assembly of claim 14, said fill assembly comprising a tubular fill pipe operably secured to said unit and having a quick-connect valve fitting on said fill pipe.

20. The assembly of claim 19, said tubular fill pipe having a threaded inner end, said unit having a complementally threaded fill bore receiving said threaded inner end.

21. The assembly of claim 14, said fill assembly including a depending fluid delivery pipe extending into said lubrication system and operably coupled with said fill port.

22. The assembly of claim 14, said sampling assembly supported on said primary unit.

23. The assembly of claim 14, said sampling assembly comprising a tubular sampling pipe operably secured to said unit and having a quick-connect valve fitting on said sampling pipe.

24. The assembly of claim 23, said tubular sampling pipe having a threaded inner end, said unit having a complementally threaded sampling bore receiving said threaded inner end.

25. The assembly of claim 14, said sampling assembly including a depending sampling pipe extending into said lubrication system and operably coupled with said sampling port.

26. The assembly of claim 14, said breather, fill assembly, and sampling assembly each being operably supported on said unit, said unit being threadably secured to said lubrication system wall in covering relationship to an access opening in said lubrication system wall, said breather port, liquid port, and sampling port in communication with the interior of said lubrication system through said access opening.
